(19) United States
(12) Patent Application Publication
(10) Pub. No.: US 2010/0097545 A1
(43) Pub. Date: Apr. 22, 2010

(54) Lenticular display systems with offset color filter array

(75) Inventors: Michael G. Robinson, Boulder, CO (US); Douglas J. McKnight, Boulder, CO (US)

Correspondence Address: REAL D - Patent Department, by Baker & McKenzie LLP, 2001 Ross Avenue, Suite 2300, Dallas, TX, 75201, US

(73) Assignee: Real D, Beverly Hills, CA (US)

(21) Appl. No.: 12/579,178

(22) Filed: Oct. 14, 2009

Related U.S. Application Data
(60) Provisional application No. 61/105,397, filed on Oct. 14, 2008.

(51) Int. Cl. G02F 1/1335; G02F 1/13

(52) U.S. Cl. 349/95; 349/187

(57) ABSTRACT

Disclosed are various lenticular display systems that include either a color filter array (CFA) or a colored lens array that is spaced from the pixels of an underlying display panel. In an embodiment, the CFA of a lenticular display may be operable to provides a locally ‘static color’ reproduction of images as a function of viewing angle. It may also enable the resolution of the CFA to be relatively coarse. Both separating the CFA from the panel and reducing the resolution significantly may reduce the system cost and allow higher resolution to be realized.

### CROSS-REFERENCE TO RELATED APPLICATIONS

This application claims priority to U.S. Provisional Appl. Ser. No. 61/105,397, entitled “Autostereoscopic display with offset color filter array,” filed on Oct. 14, 2008, which is hereby incorporated by reference in its entirety for all purposes.

### TECHNICAL FIELD

The disclosed embodiments relate generally to lenticular display systems and, more specifically, to lenticular display systems comprising a color filter array in spaced relation with an underlying panel.

### BACKGROUND

Autostereoscopic displays have a long history dating back many decades. The basic principle of autostereoscopic display includes inserting a micro-optical array between a 2D display and the viewer so as to provide angularly dependent images. These underlying pixels include spatially-separated modulating elements of different colors (e.g. red, green, and blue). Relying on the refractive property of the lenses in the optical array, the optical array is operable to “hide” certain pixels at any given viewing angle and provide an image only with those pixels that remain visible. As such, the visible pixels are selectively chosen to create effective pixels for each view.

Conventional autostereoscopic displays typically include a conventional LCD panel and a cylindrical lens array. Display pixels include a triad of rectangular red (R), green (G) and blue (B) subpixels aligned in contiguous columns. A cylindrical lens array is introduced directly in front of the display to provide multiple views by selectively imaging the pixels in the plane of the viewer.

### SUMMARY

Provided in the present disclosure is an exemplary embodiment of a lenticular display system including a display panel having a plurality of pixels operable to output light. The lenticular display system further includes a plurality of lenses disposed in the light paths of the light output by the plurality of pixels and a color filter array disposed between the plurality of pixels and the plurality of lenses, the color filter array may be adjacent to the plurality of lenses and spaced from the plurality of pixels.

Another embodiment provided in the present disclosure is directed to a lenticular display system including a display panel having a plurality of pixels operable to output light. This embodiment further includes a plurality of colored lenses disposed in the light paths of the light output by the plurality of pixels, the plurality of colored lenses being in spaced relation with the plurality of pixels.

The present disclosure also provides a method of manufacturing a lenticular display system, including providing a display panel having a plurality of pixels operable to output light. The method further comprises disposing a plurality of lenses in the light paths of the light output by the plurality of pixels and disposing a color filter array between the plurality of pixels and the plurality of lenses, the color filter array being adjacent to the plurality of lenses and spaced from the plurality of pixels.

### BRIEF DESCRIPTION OF THE DRAWINGS

Embodiments are illustrated by way of example in the accompanying figures in which:

FIG. 1A is a schematic diagram illustrating a slanted pixel array with an overlying cylindrical lenticular element, in accordance with the present disclosure;

FIG. 1B is a schematic diagram illustrating the effect of the cylindrical lenticular element, in accordance with the present disclosure;

FIG. 2 is a schematic diagram illustrating front and top views of effective pixels as seen from different viewing angles, in accordance with the present disclosure;

FIGS. 3A and 3B are schematic diagrams illustrating top view cross-sections of a lenticular based autostereoscopic displays, in accordance with the present disclosure;

FIG. 4A is a schematic diagram illustrating a cross-sectional top view of an exemplary embodiment, in accordance with the present disclosure;

FIG. 4B is a schematic diagram illustrating a front view of the exemplary embodiment shown in FIG. 4A, in accordance with the present disclosure;

FIG. 5 is a schematic diagram illustrating front views of an alternate color mapping for underlying pixels, in accordance with the present disclosure;

FIG. 6 is a schematic diagram illustrating a front view of an exemplary embodiment, in accordance with the present disclosure; and

FIG. 7 is a schematic diagram of a cross-sectional top view illustrating an exemplary embodiment, in accordance with the present disclosure.

### DETAILED DESCRIPTION

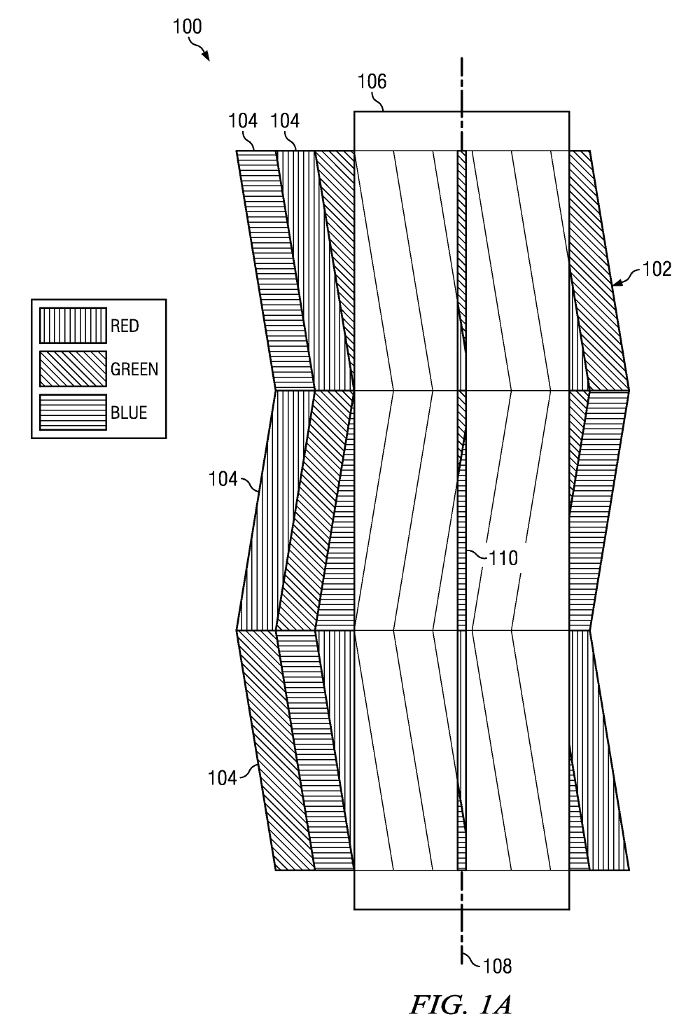

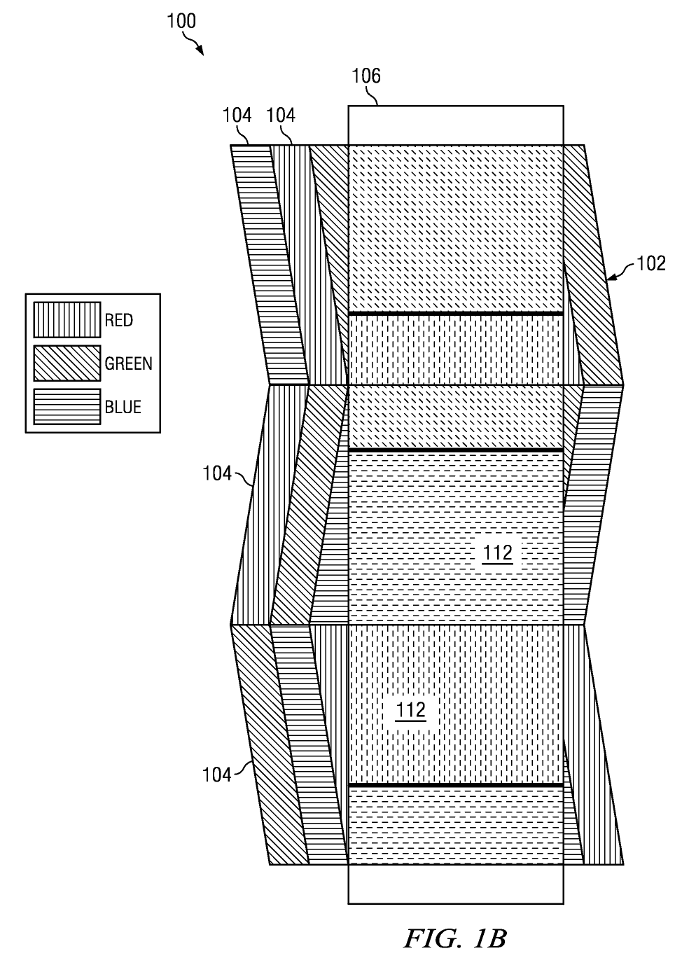

FIG. 1A is a schematic frontal view of a lenticular autostereoscopic display system 100. The basic operation of lenticular autostereoscopic display systems is provided herein with respect to the display system 100. The display system 100 comprises a pixel array 102 and lenses 106 disposed over the pixel array 102. In an embodiment, pixel array 102 may include pixels 104 that are slanted relative to the lenses 106 as illustrated in FIG. 1A. In another embodiment, the pixel array 102 may include pixels 104 that are vertically aligned and the lenses 106 are oriented at an oblique angle relative to the vertically aligned pixels 104. These oblique orientations of the pixels 104 relative to the lenses 106 allow for reducing angular and spatial intensity variation as explained in U.S. patent application Ser. No. 12/541,895, which is hereby incorporated by reference in its entirety for all purposes.

FIG. 1B is a schematic frontal view of the display system 100 having effective pixels 112. In the illustrated embodiment, the slanted pixels 104 of the display system 100 may be viewed through the cylindrical lenses 106, which selectively reveal some of the underlying pixels 104. The resultant effective pixels 112 vary as a function of viewing position and angle, which provides angle-varying images for stereoscopic 3D visualization. Effective pixels 112 can be determined at any given angle from the projection of the lens center line 108 onto the pixel array 102, as shown in FIG. 1A. In operation, light 110 passing though the center of any lens does not get deflected and hence, the pixels 104 intersected by the projected center line 108 may be viewed as if the lenses 106 were not present. The remainder of the lens 106 deflects light from the same central regions toward the viewer, giving the impression of light stretched from the center to the lens edges and forming effective pixels 112. In this manner, only the light 110 close to the projected center line 108 is seen. The pixels 102 not intersecting the projected center line 108 are hidden.

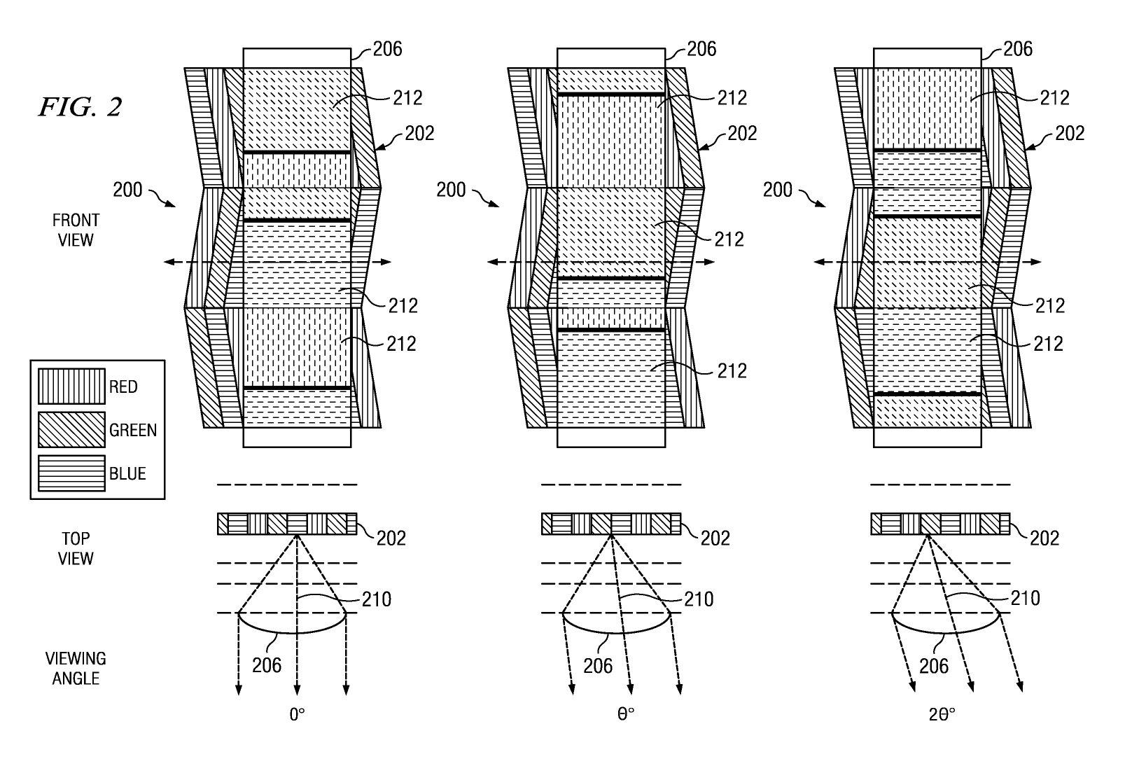

FIG. 2 includes a schematic frontal view of a lenticular display system 200 and a corresponding schematic top view of the lenticular display system 200. FIG. 2 shows how the effective pixels 212 change as a function of the viewing position, and hence, the viewing angle. Geometry dictates the movement of the projected center lines 210 of the lenses 206 since the lenses 206 are spaced from the plane of the pixel array 202 at a fixed distance. This results in the effective pixels 212 shown in FIG. 2 and illustrates the transition of the views as a function of viewing angle from 0°to θ, and from θ to 2θ.

Different views appear continuously at different viewing angles until individual lenses image the pixels under their adjacent lenses, which would result in a replication of the views. The region containing a complete set of views is the “viewing zone.” The number of views within a viewing zone is substantially equal to the number of pixels that lie beneath a lens 206 in the horizontal direction. The size of viewing zone may be determined by the focal length of the lens 206, but to provide stereoscopic images, at least two views may be included in the angle subtended by the viewer's eyes. A desirable large viewing zone is typically provided by increasing the number of pixels 204 beneath each lens 206 to increase the views. To provide for this, smaller and smaller pixels are being fabricated.

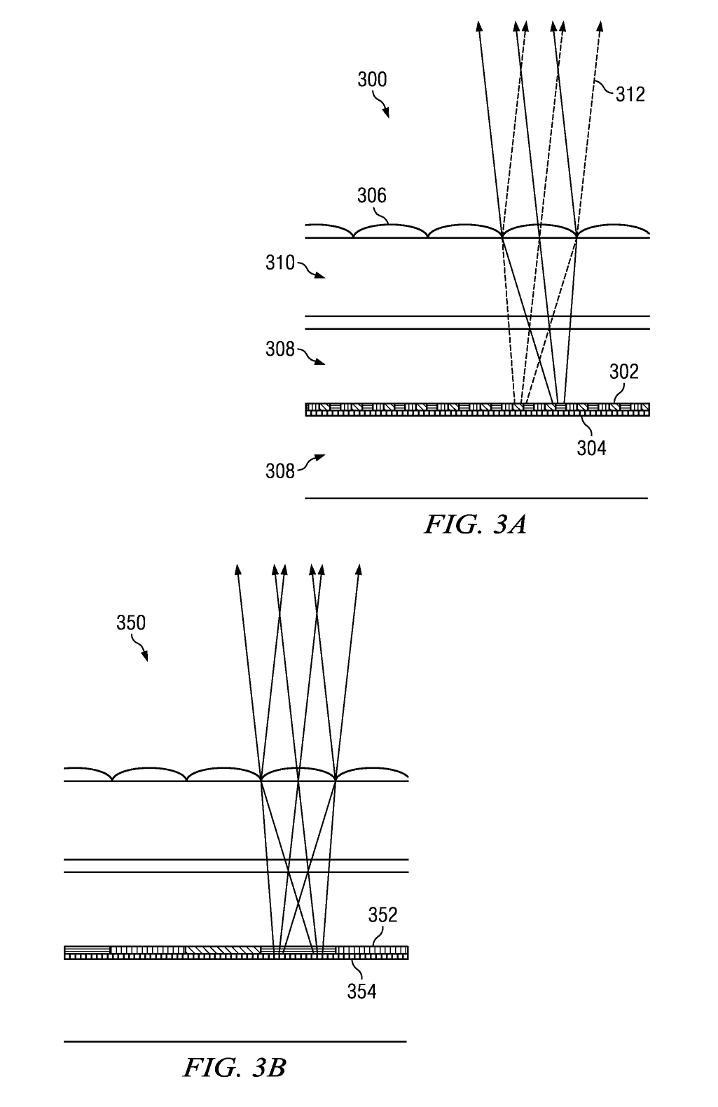

FIG. 3A is a schematic diagram illustrating a cross-sectional top view of a lenticular display system 300 with a RGB columnar color filter array (CFA) 302. The CFA 302 may comprise any color filters known in the art and may be configured to provide the desired color mapping for the lenticular display system 300. Here, the CFA 302 is configured such that colors alternate as a function of viewing angle. Lenses 306 may be disposed on a lens substrate 310 and may be positioned in the light paths 312 of light emanating from the underlying pixels 304. To ensure that each pixel 304 corresponds to one of the alternating colors, the CFA 302 may be disposed immediately adjacent to the pixels 304 between panel substrates 308. Such a close proximity of the CFA 302 and the pixels 304 may ensure that light passing through a pixel 304 would also pass through the color filter above it and may not leak into the color filter for adjacent pixel 304. In other words, by properly aligning and disposing the CFA 302 adjacent to the pixels 304, horizontal parallax can be substantially reduced. Properly aligning the CFA 302 with the underlying pixels 304, however, is an expensive, low-yield step that may increase the cost of manufacturing the display system 300. One method of reducing cost is to fabricate panels with contiguous color columns.

FIG. 3B is a schematic diagram of a cross-sectional top view of a lenticular display system 350 comprising a coarser CFA 352 that provides a ‘static color’ solution where color remains substantially the same at any given image pixel position for different viewing angles. In this embodiment, the underlying pixels may be grouped horizontally such that those situated directly beneath any one lens element output substantially the same colored light. This allows the effective pixels of the different angular views to retain substantially the same color at any given position, which may reduce the viewer's sensation of noise due to cycling of colors as a function of head position. Horizontal grouping of the pixels also may improve the ease of manufacturing and reduce the cost of the overall display system. Although the CFA 352 may be disposed immediately adjacent to the pixels 354, it is to be appreciated that the reduction of horizontal parallax is much less of a concern regardless where the CFA 352 is placed. Indeed, due to the ‘static color’ configuration, horizontal parallax may be substantially reduced by the selective nature of the coarser CFA 352.

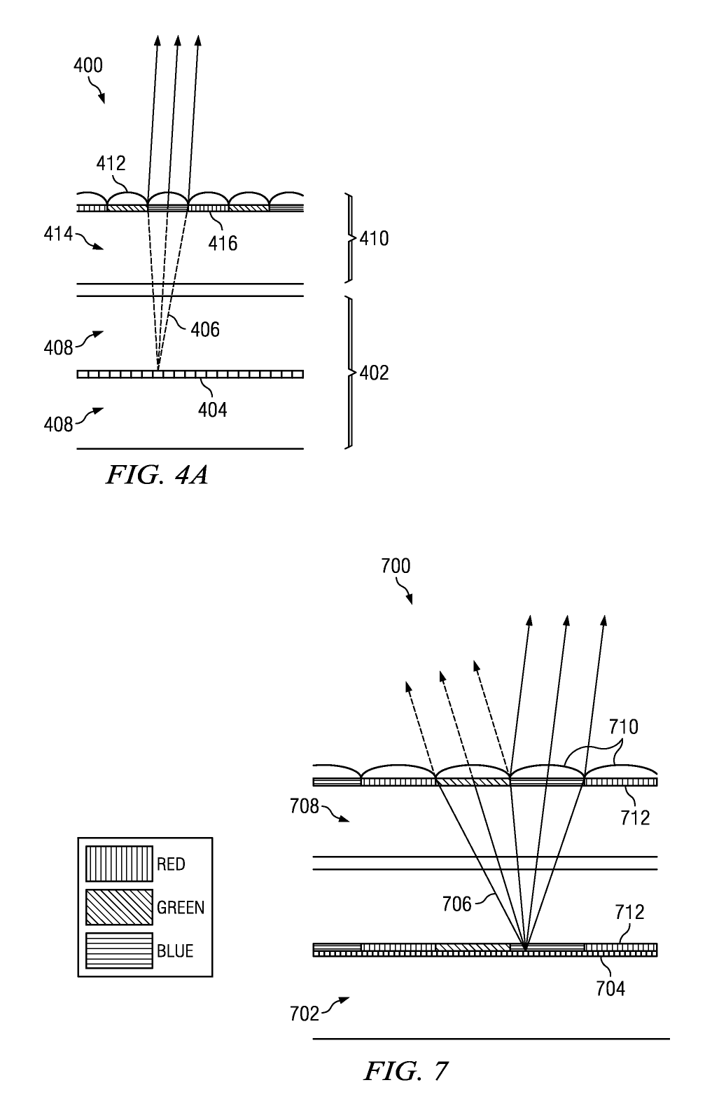

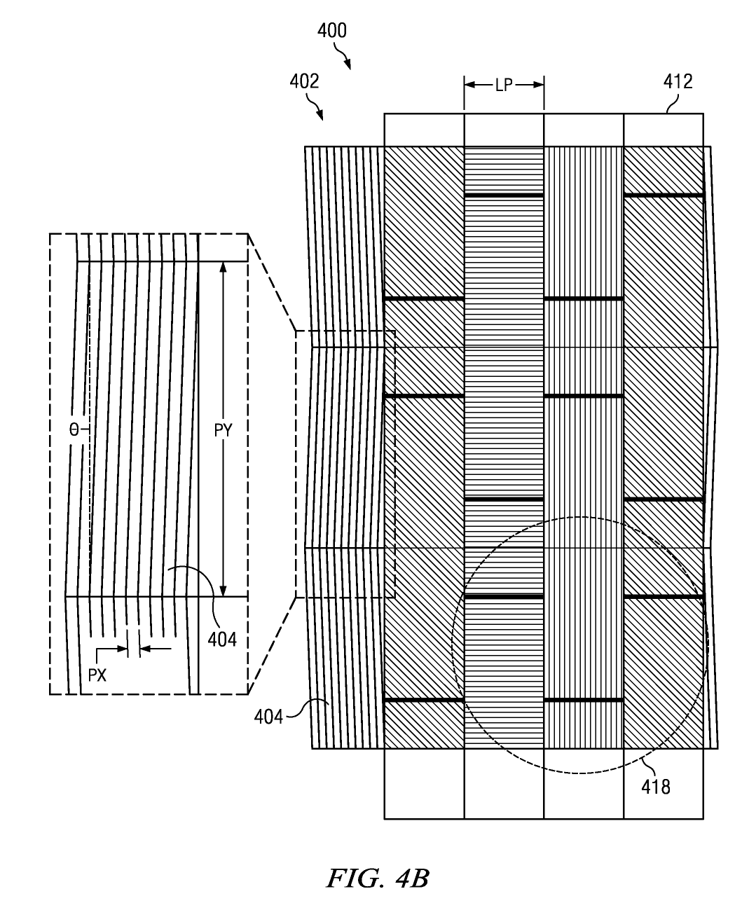

FIG. 4A is a schematic diagram illustrating a cross-sectional top view of a lenticular display system 400 in accordance with the present disclosure, and FIG. 4B is a schematic diagram showing a frontal view of the lenticular display system 400. The lenticular display system 400 includes a display panel 402 comprising a plurality of pixels 404 operable to output light along light paths 406. The panel 402 may be a monochrome panel comprising monochrome pixels 404, and the pixels 404 may be disposed between substrates 408, which may be made of glass or other suitable materials, such as polymeric materials. The lenticular display system 400 may further include a lens sheet 410 proximate to the panel 402 for directing light from the pixels 404 to a viewer. The lens sheet 410 may include a plurality of lenses 412 disposed on a lens substrate 414 and may be oriented such that the lenses 412 are in the light paths 406 of the light output by the pixels 404.

To allow for colored light, an embodiment of the display system 400 may include a color filter array (CFA) 416 disposed between the pixels 404 and the lenses 412. The CFA 418 may be configured to allow “static color” with coarse effective pixels 418. As such, the leakage of light between the CFA 416 and the pixels 404 may not compromise the performance of the display system 400, and accordingly, the CFA 416 may be disposed adjacent to the lenses 412 and spaced from the pixels 404. This embodiment may allow for the elimination of the costly, low-yield step of disposing the CFA 416 immediately next to the pixels 404 and aligning CFA 416 and the pixels 404.

In another embodiment, the lenses 412 of display system 400 may themselves be filtered (i.e., colored) by applying RGB stripes of conventional absorbing filter material directly beneath the lens array. In one exemplary embodiment, a single stripe may be associated with each cylindrical lens element.

In some embodiments, the pixels 404 of the display system 400 may include light-modulating elements, such liquid crystal cells. The pixels 404 may be oriented at oblique orientations as shown in FIG. 4B. For example, a pixel array of the display system 400 may comprise a plurality of pixels 404 arranged in a plurality of rows and columns according to a Herring-bone pattern.

In the embodiment illustrated in FIG. 4B, the horizontal pitch of the pixels px would be ˜lp/(3(N−δ)), where lp is the lens pitch and therefore the effective horizontal pixel pitch, and N is the number of views in the viewing zone. δ is typically close to 0.5 in order to reduce unwanted pattern noise in the form of moire fringes and is dependent on specific pixel structure. In some embodiments, vertical pixel pitch py may be equivalent to the lens pitch lp to provide square effective pixels. The oblique angle θ of the pixels may be between

$${tan}^{- 1} ( \frac{1}{3 N} ) and {tan}^{- 1} ( \frac{1}{2 N} ) ,$$

with the exact angle chosen again to remove moire effects. To avoid spatial color breakup, the lens pitch may be typically less than 0.3 mm for a 60″ diagonal display. Using current lithography techniques, the horizontal pixel pitch of the panel can be as small as 10 μm, making the approximate total number of views to be 30, which is compatible with a viewing zone of approximately 40°.

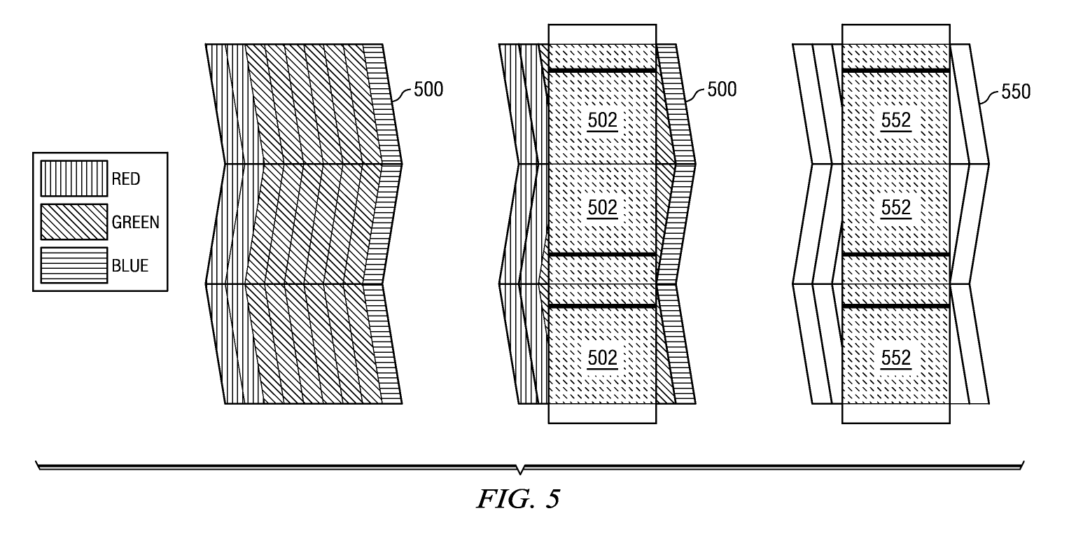

FIG. 5 is a schematic view of the color mapping of two display systems 500 and 550. Display system 500 comprises a slanted-pixel panel structure with a CFA immediately adjacent to the panel. The color mapping of the display system 500 is the uniform colored effective pixels 502 as discussed above. The display system 550 comprises grey monochrome pixels overlayed by filtered lenses. As shown in FIG. 5, the effective pixels 552 of the display system 550 is substantially equivalent to the effective pixels 502. This equivalence allows the CFA to be defined in the plane of the lenses without appreciable performance reduction within the viewing zone while providing significant cost advantages.

Outside the viewing zone, pixels situated behind any given colored lens are seen through adjacent lenses. Since alternate colored lenses are proposed, this would result in color distortion in the displayed images. For embodiments based on future applications, this may not constitute a problem as the viewing zone is expected to be sufficient for any reasonable viewing environments with super-high resolution panels. For embodiments incorporating currently available panels, the onset of color distorted images would alert the viewer to be repositioned within the viewing zone and could be beneficial for preventing viewing of the confusing images displayed at viewing zone boundaries. For embodiments directed to single-viewer systems, correction data could be applied to the underlying pixels based on the viewer's position, substantially avoiding all such issues. For example, a lenticular display system of the present disclosure may include a controller for receiving the data related to a viewer's position and display images based on the viewing zone corresponding to the viewer's position. In one exemplary embodiment, the controller of the lenticular display system may receive data from a head tracking device. This approach is particularly suitable for systems that allow complete look-around capability without the overhead of displaying multiple images simultaneously and reduces the underlying panel resolution.

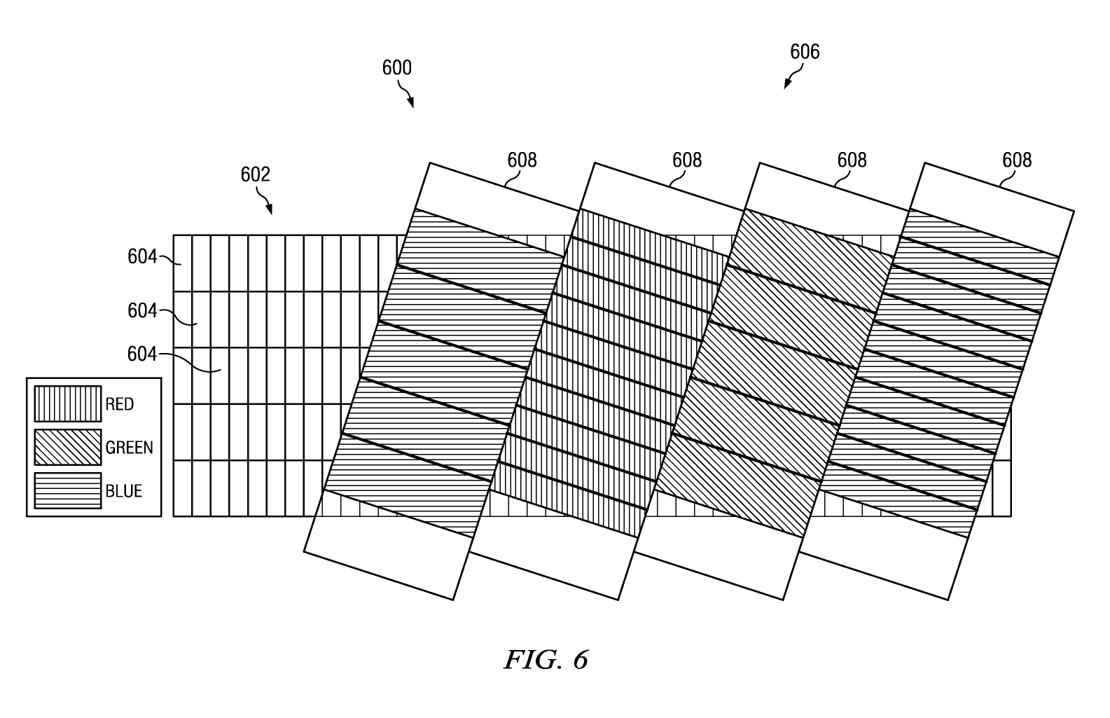

FIG. 6 is a schematic diagram showing a frontal view of an exemplary embodiment of a lenticular display system 600. The lenticular display system 600 includes a display panel 602 comprising a plurality of pixels 604 operable to output light along light paths. The panel 602 may be a monochrome panel comprising monochrome pixels 604. The lenticular display system 600 may further include a lens sheet 606 proximate to the panel 602 for directing light from the pixels 604 to a viewer. The lens sheet 606 may include a plurality of lenses 608 and may be oriented such that the lenses 608 are in the light paths of the light output by the pixels 604. To allow for colored light, an embodiment of the display system 600 may include a CFA (not shown) disposed between the pixels 604 and the lenses 608. The CFA may be disposed adjacent to the lenses 608 and spaced from the pixels 604. In another embodiment, the lenses 608 of display system 600 may themselves be color-filtered.

In the illustrated exemplary embodiment, the pixels 604 are arranged in a pixel array comprising a plurality of rows and columns, and lenses are arranged in a lens array having a plurality of rows and columns that are aligned at oblique angles relative to the rows and columns of the pixel array. In other words, the lens sheet 606 may be tilted relative to the pixels 604 to hide the global imaging of pixel boundaries.

FIG. 7 is a cross-sectional view of an exemplary embodiment of a lenticular display system 700 in accordance with the present disclosure. The lenticular display system 700 may include a display panel 702 comprising a plurality of pixels 704 operable to output light along light paths 706. The panel 702 may be a monochrome panel comprising monochrome pixels 704. The lenticular display system 700 may further include a lens sheet 708 proximate to the panel 702 for directing light from the pixels 704 to a viewer. The lens sheet 708 may include a plurality of lenses 710 and may be oriented such that the lenses 710 are in the light paths of the light output by the pixels 704.

To allow for colored light, an embodiment of the display system 700 may include a coarse 712 CFA disposed between the pixels 704 and the lenses 710. The CFA 712 may be disposed adjacent to the lenses 710 and spaced from the pixels 704. In another embodiment, the lenses 710 of display system 700 may themselves be filtered. In an embodiment, the display 700 may include a second color filter array 712 disposed between the pixels 704 and the plurality of lenses 710, and adjacent to the pixels 704 for secondary viewing zone suppression. This embodiment may allow suppression of incorrect viewing zones through complimentary filtering. Light passing through dissimilar filters may be highly attenuated effectively hiding viewing zones showing incorrect images.

While various embodiments in accordance with the principles disclosed herein have been described above, it should be understood that they have been presented by way of example only, and not limitation. Thus, the breadth and scope of the invention(s) should not be limited by any of the above-described exemplary embodiments, but should be defined only in accordance with any claims and their equivalents issuing from this disclosure. Furthermore, the above advantages and features are provided in described embodiments, but shall not limit the application of such issued claims to processes and structures accomplishing any or all of the above advantages.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

What is claimed is:

1. A lenticular display system, comprising:
a display panel comprising a plurality of pixels operable to output light;
a plurality of lenses disposed in the light paths of the light output by the plurality of pixels; and
a color filter array disposed between the plurality of pixels and the plurality of lenses, the color filter array being adjacent to the plurality of lenses and spaced from the plurality of pixels.

2. The lenticular display system of claim 1, further comprising a second color filter array disposed between the plurality of pixels and the plurality of lenses, the second color filter array being adjacent to the plurality of pixels.

3. The lenticular display system of claim 1, wherein the plurality of pixels comprise monochrome pixels.

4. The lenticular display system of claim 1, wherein the plurality of pixels comprise light-modulating elements.

5. The lenticular display system of claim 4, wherein the light-modulating elements comprise liquid crystal cells.

6. The lenticular display system of claim 1, wherein the plurality of pixels are arranged in a pixel array comprising a plurality of rows and columns, and further wherein the plurality of lenses are arranged in a lens array having a plurality of rows and columns that are aligned at oblique angles relative to the rows and columns of the pixel array.

7. The lenticular display system of claim 1, wherein the plurality of pixels are oriented at oblique orientations.

8. The lenticular display system of claim 1, wherein the plurality of pixels are arranged in a pixel array comprising a plurality of rows and columns, and further wherein the plurality of pixels are arranged in a Herring-bone pattern.

9. The lenticular display system of claim 1, wherein the plurality of lenses comprise cylindrical lenses.

10. A lenticular display system, comprising:
a display panel comprising a plurality of pixels operable to output light; and
a plurality of colored lenses disposed in the light paths of the light output by the plurality of pixels, the plurality of colored lenses being in spaced relation with the plurality of pixels.

11. The lenticular display system of claim 10, wherein the plurality of lenses comprise cylindrical lenses.

12. The lenticular display system of claim 10, wherein the plurality of pixels comprise monochrome pixels.

13. The lenticular display system of claim 10, wherein the plurality of pixels comprise light-modulating elements.

14. The lenticular display system of claim 13, wherein the light-modulating element pixels comprise liquid crystal cells.

15. The lenticular display system of claim 10, wherein the plurality of pixels are arranged in a pixel array comprising a plurality of rows and columns, and further wherein the plurality of lens are arranged in a lens array having a plurality of rows and columns that are aligned at oblique angles relative to the rows and columns of the pixel array.

16. The lenticular display system of claim 10, wherein the plurality of pixels are oriented at oblique orientations.

17. A method of manufacturing a lenticular display system, comprising:
providing a display panel comprising a plurality of pixels operable to output light;
disposing a plurality of lenses in the light paths of the light output by the plurality of pixels; and
disposing a color filter array between the plurality of pixels and the plurality of lenses, the color filter array being adjacent to the plurality of lenses and spaced from the plurality of pixels.

18. The method of claim 17, further comprising:
arranging the plurality of pixels in a pixel array comprising a plurality of rows and columns;
arranging the plurality of lens in a lens array having a plurality of rows and columns; and
positioning the lens array in an orientation where the rows and columns of the lens array are aligned at oblique angles relative to the rows and columns of the pixel array.

19. The method of claim 17, further comprising arranging the plurality of pixels at oblique orientations.

20. The method of claim 17, further comprising disposing a second color filter array between the plurality of pixels and the plurality of lenses, the second color filter array being adjacent to the plurality of pixels.
